(19) United States
(12) Patent Application Publication
(10) Pub. No.: US 2009/0057288 A1
(43) Pub. Date: Mar. 5, 2009

(54) Clothing Heating Device Whose Output Power can be Switched

(76) Inventor: Chien-Chou Chen, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/847,698

(22) Filed: Aug. 30, 2007

(51) Int. Cl. H05B 3/00

(52) U.S. Cl. 219/211

(57) ABSTRACT

A clothing heating device includes a plurality of heating plates, a battery charger, a battery, a temperature controller, and a plurality of switching wires. Thus, the power output of the clothing heating device is switched between a larger power output wherein the battery charger provides a larger electric power to the larger power heating zone of the heating plates and a smaller power output wherein the battery provides a smaller electric power to the smaller power heating zone of the heating plates so that a user can select the power output of the clothing heating device according to the practical requirement.

### BACKGROUND OF THE INVENTION

1. Field of the Invention

The present invention relates to a heating device and, more particularly, to a heating device for heating and warming a clothing to provide a comfortable sensation to a user who wears the clothing when riding a motorized vehicle, such as a motorcycle and the like.

2. Description of the Related Art

A conventional clothing heating device in accordance with the prior art shown in FIG. 6 comprises a plurality of heating plates 10 mounted on a clothing 1, a battery 12 electrically connected with the heating plates 10 by conducting wires 101 to supply an electric power to the heating plates 10, and a control switch 11 electrically connected between the battery 12 and the conducting wires 101 to control connection between the battery 12 and the heating plates 10. When in use, the battery 12 supplies the electric power to the heating plates 10 to heat the heating plates 10 to keep a user warm so as to provide a comfortable sensation to the user. However, the electric power supplied by the battery 12 has a smaller value, thereby limiting the warming effect of the clothing 1.

Another conventional clothing heating device in accordance with the prior art shown in FIG. 7 comprises a plurality of heating plates 20 mounted on a clothing 2, a battery 22 electrically connected with the heating plates 20 by conducting wires 201 to supply an electric power to the heating plates 20, and a control switch 21 electrically connected between the battery 22 and the conducting wires 201 to control connection between the battery 22 and the heating plates 20. The battery 22 is provided with a plug 221 detachably combined with a receptacle (not shown) of a vehicle battery (not shown) of a motorized vehicle (not shown), such as a motorcycle and the like, to receive the electric power from the vehicle battery. Alternatively, the plug 221 of the battery 22 is directly inserted into a receptacle (not shown) of a cigarette lighter (not shown) of the motorcycle. When in use, the vehicle battery supplies the electric power to the battery 12 to heat the heating plates 10 to keep a user warm so as to provide a comfortable sensation to the user. At the same time, the battery 12 is charged by the vehicle battery. Thus, the electric power supplied by the vehicle battery has a larger value to heat the heating plates 10 to increase the temperature of the clothing 2. However, the user has to remove the plug 221 of the battery 22 from the vehicle battery when leaving the motorcycle so that the electrical connection between the vehicle battery and the battery 12 is interrupted. Thus, the battery 12 cannot supply a larger electric power to heat the heating plates 10 when the electrical connection between the vehicle battery and the battery 12 is interrupted, thereby limiting the heating time of the clothing heating device. In addition, the user has to prepare a first clothing 1 having a smaller electric power and a second clothing 2 having a larger electric power, thereby causing inconvenience to the user.

### BRIEF SUMMARY OF THE INVENTION

In accordance with the present invention, there is provided a clothing heating device, comprising a plurality of heating plates mounted on a clothing to form a larger power heating zone and a smaller power heating zone on the clothing, a battery charger electrically connected with the larger power heating zone of the heating plates to provide a larger electric power to the larger power heating zone of the heating plates, a battery electrically connected with the battery charger to receive the larger electric power of the battery charger and electrically connected with the smaller power heating zone of the heating plates to provide a smaller electric power to the smaller power heating zone of the heating plates, a temperature controller electrically connected between the battery and the smaller power heating zone of the heating plates, and a plurality of switching wires electrically connected with the heating plates to switch a power output of the heating plates between a larger power output wherein the battery charger provides the larger electric power to the larger power heating zone of the heating plates and a smaller power output wherein the battery provides the smaller electric power to the smaller power heating zone of the heating plates.

The battery is provided with a relay, wherein the battery is not electrically connected with the temperature controller when the relay is open so that the battery is not electrically connected with the smaller power heating zone of the heating plates when the battery is charged, and the battery is electrically connected with the temperature controller when the relay is closed so that the battery is electrically connected with the smaller power heating zone of the heating plates when the battery is not charged.

The primary objective of the present invention is to provide a clothing heating device whose output power can be switched.

Another objective of the present invention is to provide a clothing heating device, wherein the power output of the clothing heating device is switched between a larger power output wherein the battery charger provides the larger electric power to the larger power heating zone of the heating plates and a smaller power output wherein the battery provides the smaller electric power to the smaller power heating zone of the heating plates so that the user can select the power output of the clothing heating device according to the practical requirement, thereby enhancing the versatility of the clothing heating device.

A further objective of the present invention is to provide a clothing heating device, wherein the temperature controller is operated to control the temperature of the heating plates step by step so as to adjust temperature of the clothing heating device, thereby facilitating the user regulating the temperature of the clothing.

A further objective of the present invention is to provide a clothing heating device, wherein the power output of the clothing heating device is switched between a larger power output and a smaller power output so that the user only needs to prepare a single piece of clothing, thereby facilitating the user wearing and storing the clothing.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a clothing heating device in accordance with the preferred embodiment of the present invention.

FIG. 2 is a circuit layout of the clothing heating device as shown in FIG. 1.

FIG. 3 is a circuit layout of the clothing heating device as shown in FIG. 1.

FIG. 4 is a circuit layout of heating plates of the clothing heating device as shown in FIG. 1.

FIG. 5 is another circuit layout of heating plates of the clothing heating device as shown in FIG. 1.

FIG. 6 is a front view of a conventional clothing heating device in accordance with the prior art.

FIG. 7 is a front view of another conventional clothing heating device in accordance with the prior art.

### DETAILED DESCRIPTION OF THE INVENTION

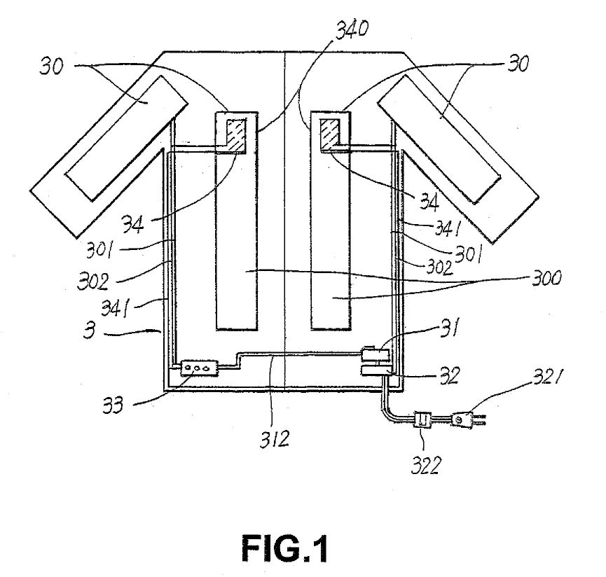

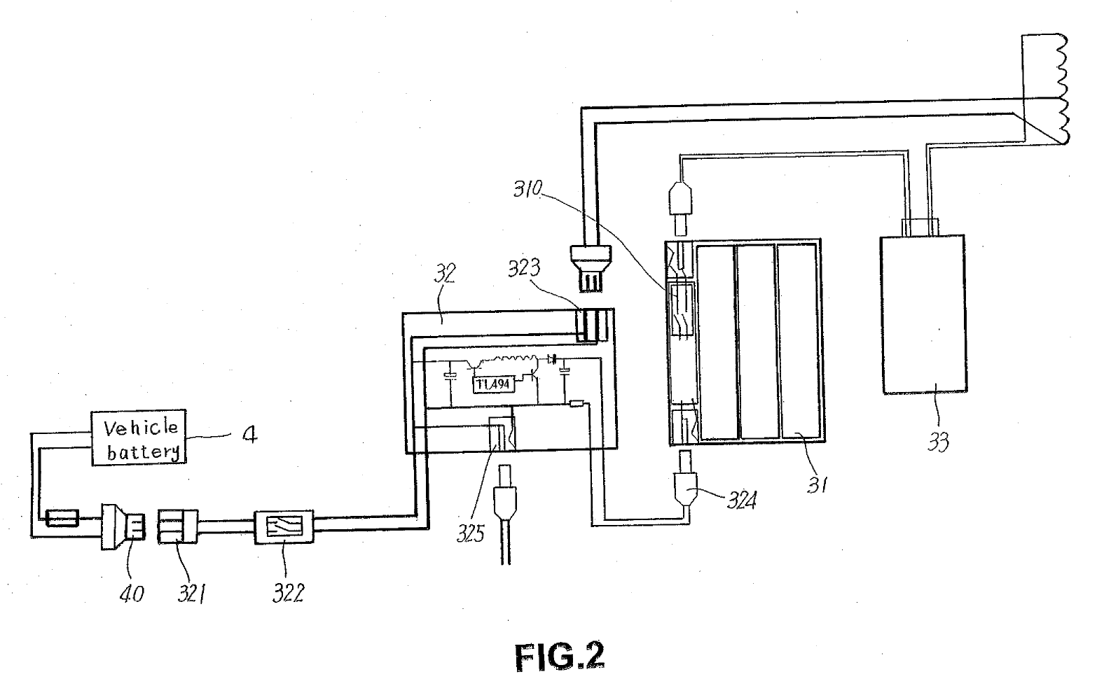

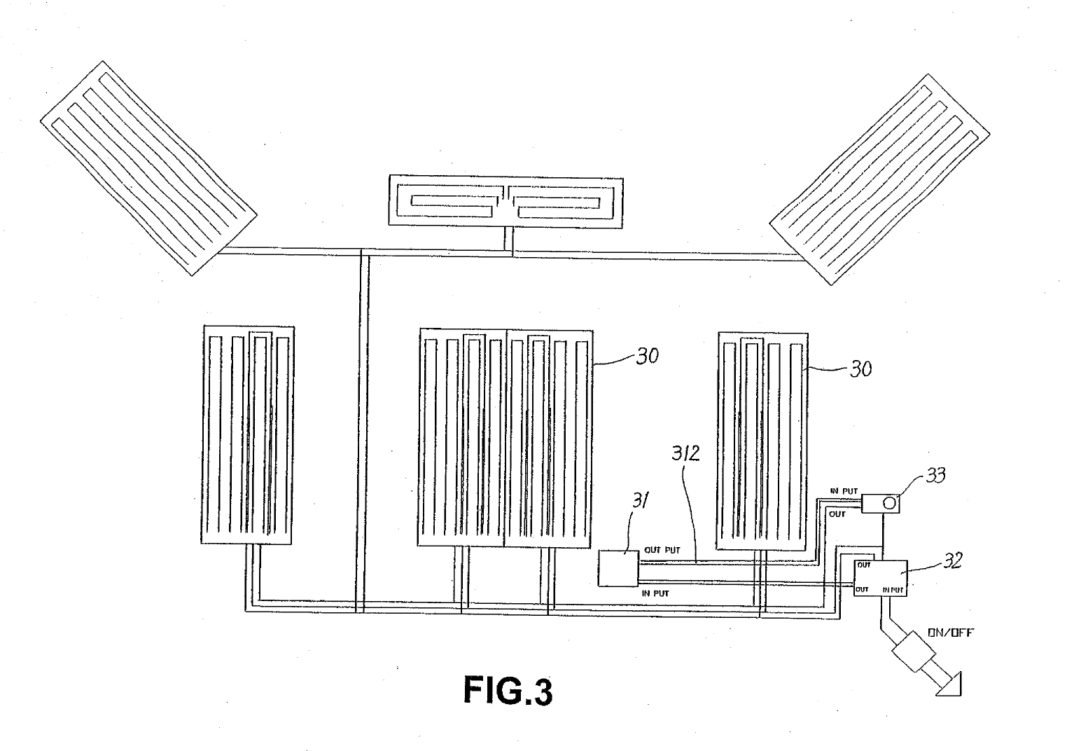

Referring to the drawings and initially to FIGS. 1-3, a clothing heating device in accordance with the preferred embodiment of the present invention comprises a plurality of heating plates 30 mounted on a clothing 3 to form a larger power heating zone 300 and a smaller power heating zone 340 on the clothing 3, a battery charger 32 electrically connected with the larger power heating zone 300 of the heating plates 30 to provide a larger electric power to the larger power heating zone 300 of the heating plates 30, a battery 31 electrically connected with the battery charger 32 to receive the larger electric power of the battery charger 32 and electrically connected with the smaller power heating zone 340 of the heating plates 30 to provide a smaller electric power to the smaller power heating zone 340 of the heating plates 30, a temperature controller 33 electrically connected between the battery 31 and the smaller power heating zone 340 of the heating plates 30, and a plurality of switching wires 34 electrically connected with the heating plates 30 to switch a power output of the heating plates 30 between a larger power output wherein the battery charger 32 provides the larger electric power to the larger power heating zone 300 of the heating plates 30 and a smaller power output wherein the battery 31 provides the smaller electric power to the smaller power heating zone 340 of the heating plates 30.

The smaller power heating zone 340 of the heating plates 30 are enclosed by the switching wires 34 and has an area smaller than that of the larger power heating zone 300 of the heating plates 30.

The battery charger 32 is provided with a plug 321 detachably combined with a receptacle 40 of a vehicle battery 4 of a motorized vehicle, such as a motorcycle and the like, to receive the larger electric power from the vehicle battery 4. Alternatively, the plug 321 of the battery charger 32 is directly inserted into a receptacle (not shown) of a cigarette lighter (not shown) of the motorcycle. The battery charger 32 is further provided with a control switch 322 to switch the larger electric power from the vehicle battery 4 to the battery charger 32. The battery charger 32 is further provided with a charging connector 324 detachably connected with the battery 31 to supply the larger electric power to the battery 31. The battery charger 32 is further provided with a connecting seat 323 electrically connected with larger power heating filaments (not shown) to heat the larger power heating zone 300 of the heating plates 30. The battery charger 32 is further provided with a conducting seat 325 for connecting an external power supply.

The battery 31 is electrically connected with the temperature controller 33 by conducting wires 312. The battery 31 is electrically connected with smaller power heating filaments (not shown) by conducting wires (not shown) to heat the smaller power heating zone 340 of the heating plates 30. The battery 31 is provided with a relay 310 wherein the battery 31 is not electrically connected with the temperature controller 33 when the relay 310 is open so that the battery 31 is not electrically connected with the smaller power heating zone 340 of the heating plates 30 when the battery 31 is charged, and the battery 31 is electrically connected with the temperature controller 33 when the relay 310 is closed so that the battery 31 is electrically connected with the smaller power heating zone 340 of the heating plates 30 when the battery 31 is not charged.

When a user wishes to use the larger power heating zone 300 of the heating plates 30, the plug 321 of the battery charger 32 is combined with the receptacle 40 of the vehicle battery 4, and the control switch 322 is opened so that the larger electric power from the vehicle battery 4 is supplied into the battery charger 32. At this time, the connecting seat 323 of the battery charger 32 is electrically connected with the larger power heating filaments so that the larger electric power of the battery charger 32 is supplied into the larger power heating filaments to heat the larger power heating zone 300 of the heating plates 30. At the same time, the charging connector 324 of the battery charger 32 is connected with the battery 31 so that the larger electric power of the battery charger 32 is supplied into the battery 31 to charge the battery 31 when the larger power heating zone 300 of the heating plates 30 is heated. At this time, the relay 310 is open, so that the battery 31 is not electrically connected with the temperature controller 33 when the battery 31 is charged.

Alternatively, when the user wishes to use the smaller power heating zone 340 of the heating plates 30 (or when the user leaves the motorcycle), the control switch 322 is closed or the plug 321 of the battery charger 32 is detached from the receptacle 40 of the vehicle battery 4, so that the electrical connection between the vehicle battery 4 and the battery charger 32 is interrupted, and the battery 31 stops charging. At this time, the relay 310 is closed, so that the battery 31 is electrically connected with the temperature controller 33 when the battery 31 stops charging. At the same time, the battery 31 is electrically connected with the smaller power heating filaments so that the smaller electric power of the battery 31 is supplied into the smaller power heating filaments to heat the smaller power heating zone 340 of the heating plates 30. In addition, the temperature controller 33 is operated to control the temperature of the smaller power heating zone 340 of the heating plates 30.

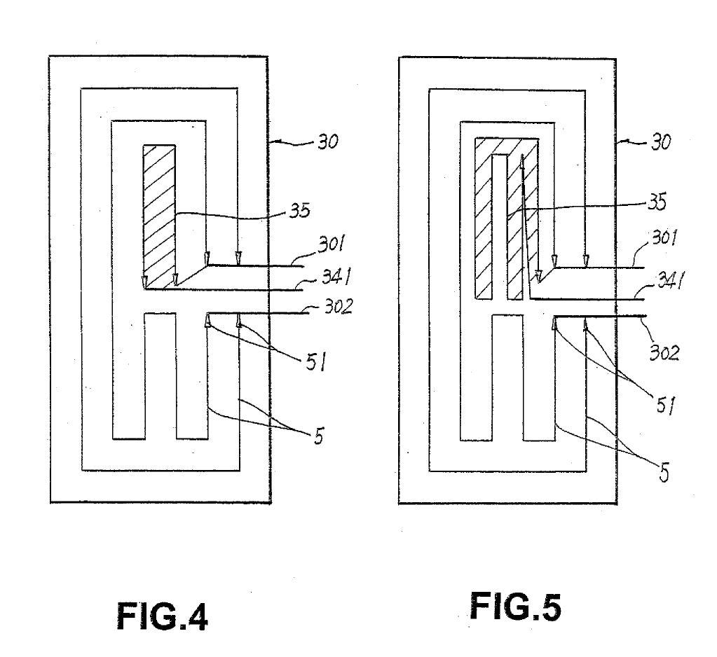

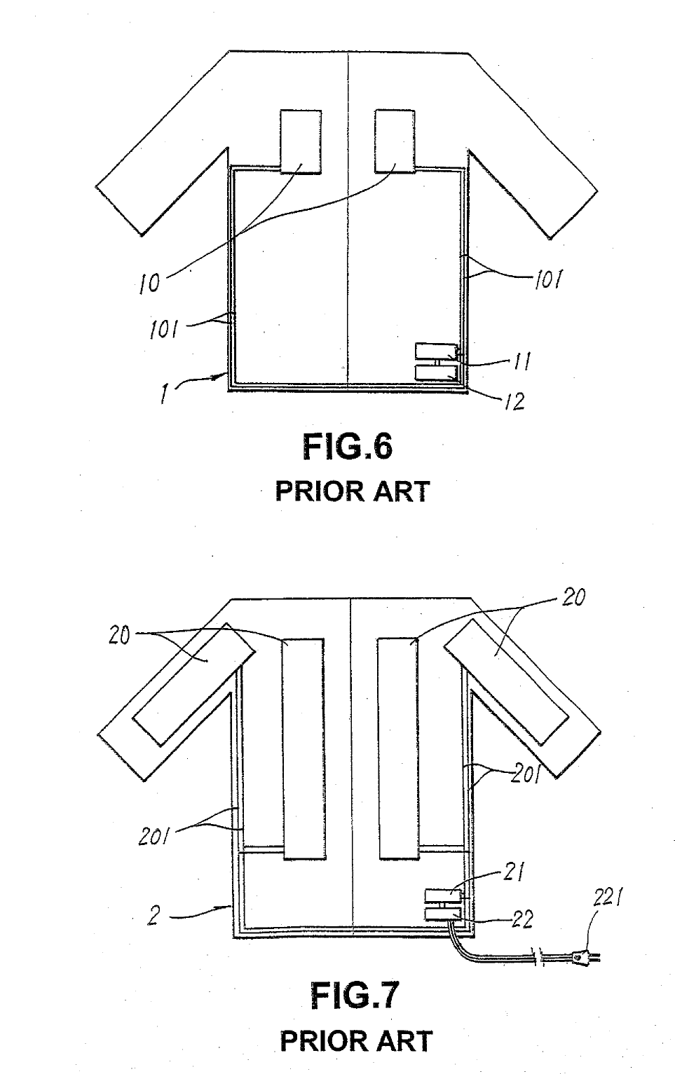

As shown in FIG. 4, the heating plates 30 are arranged in a double voltage manner. A plurality of carbon fiber filaments 5 (the larger power heating filaments) are arranged in the heating plates 30 and are positioned by hubs 51. Each of the carbon fiber filaments 5 has a first end (the positive pole) electrically connected with a first conducting wire 301 and a second end (the negative pole) electrically connected with a second conducting wire 302. A heating strip 35 (the smaller power heating filaments) having a smaller area is also arranged in the heating plates 30 and has a first end (the positive pole) electrically connected with the first conducting wire 301 and a second end (the negative pole) electrically connected with a third conducting wire 341 which is electrically connected with the switching wires 34.

In practice, the switching wires 34 are switched between a first position where the first conducting wire 301 and the second conducting wire 302 are conducted electrically and a second position where the first conducting wire 301 and the third conducting wire 341 are conducted electrically. In such a manner, when the first conducting wire 301 and the second conducting wire 302 are conducted electrically, the carbon fiber filaments 5 are heated by the larger electric power (12V and 20 W) to heat the larger power heating zone 300 of the heating plates 30. On the contrary, when the first conducting wire 301 and the third conducting wire 341 are conducted electrically, the heating strip 35 is heated by the smaller electric power (7.4V and 2 W) to heat the smaller power heating zone 340 of the heating plates 30.

As shown in FIG. 5, the heating plates 30 are arranged in a single voltage manner. A plurality of carbon fiber filaments 5 (the larger power heating filaments) are arranged in the heating plates 30 and are positioned by hubs 51. Each of the carbon fiber filaments 5 has a first end (the positive pole) electrically connected with a first conducting wire 301 and a second end (the negative pole) electrically connected with a second conducting wire 302. A heating strip 35 (the smaller power heating filaments) having a smaller area is also arranged in the heating plates 30 and has a first end (the positive pole) electrically connected with the first conducting wire 301 and a second end (the negative pole) electrically connected with a third conducting wire 341 which is electrically connected with the switching wires 34.

In practice, the switching wires 34 are switched between a first position where the first conducting wire 301 and the second conducting wire 302 are conducted electrically and a second position where the first conducting wire 301 and the third conducting wire 341 are conducted electrically. In such a manner, when the first conducting wire 301 and the second conducting wire 302 are conducted electrically, the second conducting wire 302 has a resistance smaller than that of the carbon fiber filaments 5 so that the current with the larger electric power (12V and 20 W) passes through the first conducting wire 301 and the carbon fiber filaments 5 into the second conducting wire 302 to heat the larger power heating zone 300 of the heating plates 30. On the contrary, when the first conducting wire 301 and the third conducting wire 341 are conducted electrically, the current with the smaller electric power (12V and 2 W) passes through the first conducting wire 301 and the heating strip 35 into the third conducting wire 341 to heat the smaller power heating zone 340 of the heating plates 30.

In operation, referring to FIGS. 1-5, when a user wearing the clothing 3 wishes to use the larger power heating zone 300 of the heating plates 30, the plug 321 of the battery charger 32 is combined with the receptacle 40 of the vehicle battery 4 (or the plug 321 of the battery charger 32 is directly inserted into a receptacle of a cigarette lighter of the motorcycle), and the control switch 322 is opened so that the larger electric power from the vehicle battery 4 is supplied into the battery charger 32. At this time, the connecting seat 323 of the battery charger 32 is electrically connected with the larger power heating filaments so that the larger electric power of the battery charger 32 is supplied into the larger power heating filaments to heat the larger power heating zone 300 of the heating plates 30 to keep the clothing 3 warm so as to provide a comfortable sensation to the user. At the same time, the charging connector 324 of the battery charger 32 is connected with the battery 31 so that the larger electric power of the battery charger 32 is supplied into the battery 31 to charge the battery 31 when the larger power heating zone 300 of the heating plates 30 is heated. At this time, the relay 310 is open, so that the battery 31 is not electrically connected with the temperature controller 33 when the battery 31 is charged to prevent the electrical energy of the battery 31 from being transmitted to the temperature controller 33 such that the battery 31 is disposed at a saturated state.

Alternatively, when the user wishes to use the smaller power heating zone 340 of the heating plates 30 (or when the user leaves the motorcycle), the control switch 322 is closed or the plug 321 of the battery charger 32 is detached from the receptacle 40 of the vehicle battery 4, so that the electrical connection between the vehicle battery 4 and the battery charger 32 is interrupted, the battery 31 stops charging, and the battery 31 supplies the smaller electric power to the heating plates 30. At this time, the relay 310 is closed, so that the battery 31 is electrically connected with the temperature controller 33 when the battery 31 stops charging, and the electrical energy of the battery 31 is transmitted to the temperature controller 33. At the same time, the battery 31 is electrically connected with the smaller power heating filaments so that the smaller electric power of the battery 31 is supplied into the smaller power heating filaments to heat the smaller power heating zone 340 of the heating plates 30. In addition, the temperature controller 33 is operated to control the temperature of the smaller power heating zone 340 of the heating plates 30. In addition, the temperature controller 33 is operated to control the temperature of the heating plates 30 step by step so as to adjust temperature of the clothing heating device, thereby facilitating the user regulating the temperature of the clothing 3.

Accordingly, the power output of the clothing heating device is switched between a larger power output wherein the battery charger 32 provides the larger electric power to the larger power heating zone 300 of the heating plates 30 and a smaller power output wherein the battery 31 provides the smaller electric power to the smaller power heating zone 340 of the heating plates 30 so that the user can select the power output of the clothing heating device according to the practical requirement, thereby enhancing the versatility of the clothing heating device. In addition, the temperature controller 33 is operated to control the temperature of the heating plates 30 step by step so as to adjust temperature of the clothing heating device, thereby facilitating the user regulating the temperature of the clothing 3. Further, the power output of the clothing heating device is switched between a larger power output and a smaller power output so that the user only needs to prepare a single piece of clothing, thereby facilitating the user wearing and storing the clothing.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A clothing heating device, comprising:
a plurality of heating plates mounted on a clothing to form a larger power heating zone and a smaller power heating zone on the clothing;
a battery charger electrically connected with the larger power heating zone of the heating plates to provide a larger electric power to the larger power heating zone of the heating plates;
a battery electrically connected with the battery charger to receive the larger electric power of the battery charger and electrically connected with the smaller power heating zone of the heating plates to provide a smaller electric power to the smaller power heating zone of the heating plates;
a temperature controller electrically connected between the battery and the smaller power heating zone of the heating plates;
a plurality of switching wires electrically connected with the heating plates to switch a power output of the heating plates between a larger power output wherein the battery charger provides the larger electric power to the larger power heating zone of the heating plates and a smaller power output wherein the battery provides the smaller electric power to the smaller power heating zone of the heating plates.

2. The clothing heating device in accordance with claim 1, wherein
the battery is provided with a relay;
the battery is not electrically connected with the temperature controller when the relay is open so that the battery is not electrically connected with the smaller power heating zone of the heating plates when the battery is charged;
the battery is electrically connected with the temperature controller when the relay is closed so that the battery is electrically connected with the smaller power heating zone of the heating plates when the battery is not charged.

3. The clothing heating device in accordance with claim 1, wherein the smaller power heating zone of the heating plates are enclosed by the switching wires.

4. The clothing heating device in accordance with claim 1, wherein the smaller power heating zone of the heating plates has an area smaller than that of the larger power heating zone of the heating plates.

5. The clothing heating device in accordance with claim 1, wherein the battery charger is provided with a plug detachably combined with a receptacle of a vehicle battery to receive the larger electric power from the vehicle battery.

6. The clothing heating device in accordance with claim 1, wherein the temperature controller is electrically connected to the smaller power heating zone of the heating plates by conducting wires.
